(19) United States
(12) Patent Application Publication
(10) Pub. No.: US 2023/0297811 A1
(43) Pub. Date: Sep. 21, 2023

(54) LEARNING APPARATUS, METHOD AND INFERENCE SYSTEM

(71) Applicant: KABUSHIKI KAISHA TOSHIBA, Tokyo (JP)

(72) Inventors: Atsushi YAGUCHI, Tokyo (JP); Shuhei NITTA, Tokyo (JP); Akiyuki TANIZAWA, Kawasaki (JP); Ryusuke HIRAI, Tokyo (JP)

(73) Assignee: KABUSHIKI KAISHA TOSHIBA, Tokyo (JP)

(21) Appl. No.: 17/823,775

(22) Filed: Aug. 31, 2022

(30) Foreign Application Priority Data
Mar. 17, 2022 (JP) 2022-042554

(51) Int. Cl. G06N 3/04; G06N 3/08

(52) U.S. Cl. CPC G06N 3/0454; G06N 3/08

(57) ABSTRACT

According to one embodiment, a learning apparatus includes a processor. The processor divides target data into pieces of partial data. The processor inputs the pieces of partial data into a first network model to output a first prediction result and calculates a first confidence indicating a degree of contribution to the first prediction result. The processor inputs the target data into a second network model to output a second prediction result and calculates a second confidence indicating a degree of contribution to the second prediction result. The processor updates a parameter of the first network model, based on the first prediction result, the second prediction result, the first confidence and the second confidence.

### CROSS-REFERENCE TO RELATED APPLICATIONS

This application is based upon and claims the benefit of priority from Japanese Patent Application No. 2022-042554, filed Mar. 17, 2022, the entire contents of which are incorporated herein by reference.

### FIELD

Embodiments described herein relate generally to a learning apparatus, method and an inference system.

### BACKGROUND

In recent years, proposed has been distributed inference processing in which inference processing in a deep neural network (DNN) is distributed so as to be performed by a plurality of edge devices. Such distributed inference processing enables adaptive utilization of the resources of a plurality of edge devices, so that the load in processing can be distributed and additionally stable processing that is unlikely to stop at the time of trouble can be achieved.

However, distributed inference requires communication of intermediate data between devices in order to keep the accuracy of inference. Thus, a large amount of intermediate data causes an increase in traffic, resulting in a drop in processing speed. For a reduction in traffic, there is a technique in which different edge devices process a plurality of patch images as partial images of an image, but the amount of information of a patch image is small, leading to difficulty in keeping the performance of inference of DNN.

### BRIEF DESCRIPTION OF THE DRAWINGS

FIG. 1 is a block diagram of a learning apparatus according to a first embodiment.

FIG. 2 is a flowchart of exemplary training of the learning apparatus according to the first embodiment.

FIG. 3 is an explanatory view of exemplary division into patch images.

FIG. 4 is a conceptual diagram of exemplary embedding of positional information with a padding technique varying in accordance with position.

FIG. 5 illustrates a first exemplary structure of a first network model and a second network model.

FIG. 6 is a conceptual diagram of a first exemplary inference system that performs distributed inference.

FIG. 7 illustrates a second exemplary structure of a first network model and a second network model.

FIG. 8 is a conceptual diagram of a second exemplary inference system that performs distributed inference.

FIG. 9 is a flowchart of exemplary training of a learning apparatus according to a second embodiment.

FIG. 10 is a block diagram of a learning apparatus according to a third embodiment.

FIG. 11 is a flowchart of exemplary training of the learning apparatus according to the third embodiment.

FIG. 12 is a block diagram of the hardware configuration of a learning apparatus.

### DETAILED DESCRIPTION

In general, according to one embodiment, a learning apparatus includes a processor. The processor divides target data into pieces of partial data. The processor inputs the pieces of partial data into a first network model to output a first prediction result. The processor calculates a first confidence indicating a degree of contribution to the first prediction result, for each of the pieces of partial data. The processor inputs the target data into a second network model to output a second prediction result. The processor calculates a second confidence indicating a degree of contribution to the second prediction result, for a region corresponding to each of the pieces of partial data in the target data. The processor updates a parameter of the first network model, based on the first prediction result, the second prediction result, the first confidence and the second confidence.

A learning apparatus, a method, a program, and an inference system according to embodiments will be described in detail below with reference to the drawings. Note that, in the following embodiments, constituent elements denoted with the same reference signs are similar in operation and thus the duplicate descriptions thereof will be appropriately omitted.

### First Embodiment

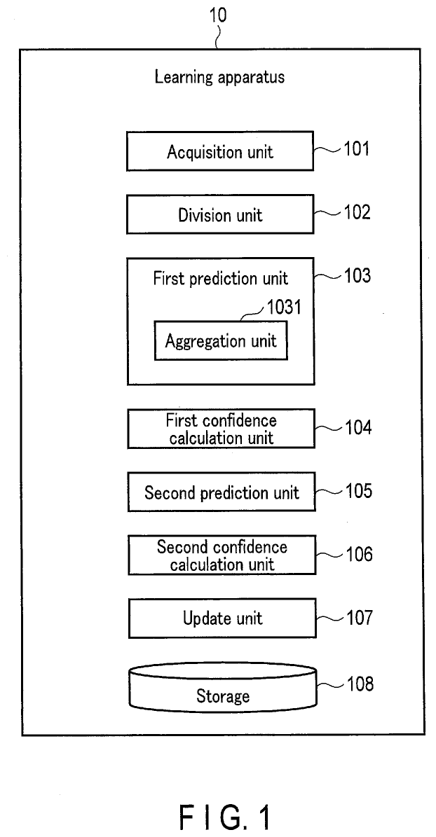

A learning apparatus according to a first embodiment will be described with reference to the block diagram of FIG. 1.

The learning apparatus 10 according to the first embodiment includes an acquisition unit 101, a division unit 102, a first prediction unit 103, a first confidence calculation unit 104, a second prediction unit 105, a second confidence calculation unit 106, an update unit 107, and a storage unit 108.

The acquisition unit 101 acquires, from the storage unit 108 to be described below or from outside, target data as data for training of network models.

The division unit 102 divides the target data into pieces of partial data.

The first prediction unit 103 inputs the pieces of partial data into a first network model to output a first prediction result.

The first confidence calculation unit 104 calculates a first confidence indicating the degree of contribution to the first prediction result, for each of the pieces of partial data.

The second prediction unit 105 inputs the target data into a second network model to output a second prediction result. The second network model may be different in model structure from the first network model or may be identical in model structure to and be different in parameter from the first network model.

The second confidence calculation unit 106 calculates a second confidence indicating the degree of contribution to the second prediction result, for a region corresponding to a piece of partial data in the target data.

The update unit 107 updates the parameter of the first network model, based on the difference between the first prediction result and the second prediction result and the difference between the first confidence and the second confidence. In a case where the second network model is not a trained model, the update unit 107 updates the parameter of the second network model. Due to completion of training of the first network model and the second network model, respective trained models are generated.

The storage unit 108 stores, for example, the target data, the first network model, the second network model, parameter values regarding network models, and trained models.

The first prediction unit 103 includes an aggregation unit 1031. The aggregation unit 1031 generates intermediate data regarding feature extraction of the pieces of partial data from the first network model, weights the intermediate data, based on confidence, and performs ensemble processing to the weighted intermediate data, to output the first prediction result.

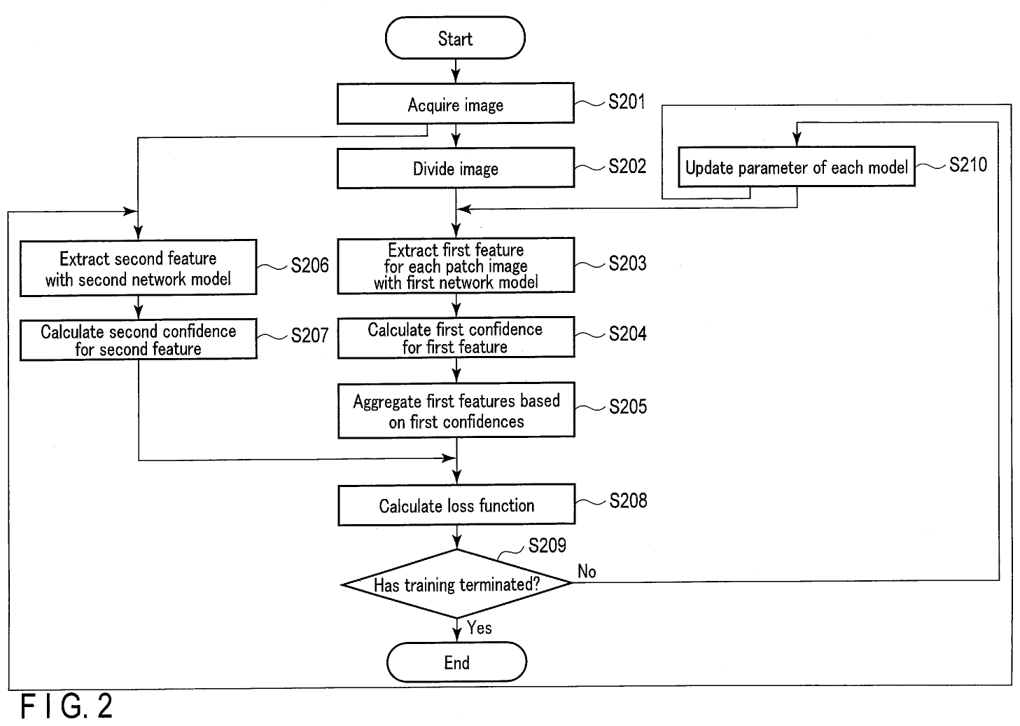

Next, exemplary training of the learning apparatus 10 according to the first embodiment will be described with reference to the flowchart of FIG. 2. Note that, in the present embodiment, a classification task will be exemplarily described as an inference task, but other tasks may be provided, such as a segmentation task, an object detection task, and a regression task.

In step S201, the acquisition unit 101 acquires target data. In the following, the target data corresponds to an image, but this is not limiting. Multidimensional data, such as two-or-more dimensional data, or one-dimensional time-series data, such as sound data or a sensor value acquired from a sensor, can processed in a similar manner.

In step S202, the division unit 102 divides the target data into pieces of partial data. Herein, the division unit 102 divides the image into a plurality of partial images (hereinafter, referred to as patch images). For convenience of description, the image acquired in step S201 before division into patch images is referred to as an entire image.

In step S203, the first prediction unit 103 extracts a first feature for each patch image with the first network model. The first network model serves as a network model that extracts the feature of data and corresponds to a deep neural network model including a convolutional neural network (CNN), such as ResNet. Note that not only ResNet but also any network model for use in feature extraction or dimensionality reduction can be applied.

In step S204, the first confidence calculation unit 104 calculates a first confidence for each extracted first feature. The first confidence is preferably calculated from information on a region of interest acquired from the intermediate data of the first network model, such as saliency or attention. The first confidence is, for example, a value of from 0 to 1.

In step S205, the aggregation unit 1031 aggregates the first features, based on the first confidences, to output a first prediction result. Herein, for example, due to ensemble processing with the weighted mean of the first features responsive to the first confidences, the first features are aggregated.

Specifically, in a case where the feature output from the first network model for each of q number of patch images (q is an integer of 2 or more) is defined as lᵢ (i is an integer satisfying 1≤i≤q) and the first confidence is defined as cᵢ, the aggregated feature l^{p} is given by Expression (1).

$${l}^{p} = {\sum }_{i = 1}^{q} {c}_{i} {l}_{i} \qquad ( 1 )$$

Note that, as the aggregated feature l^{p}, the feature lᵢ of which the first confidence cᵢ is maximum may be adopted. In a case where the logit of the aggregated feature l^{p} is defined as x and a weight factor and a bias are defined as W and b, respectively, as parameters for the classifier of the first network model to be trained, for example, the first prediction result y^{p} is given by the following Expression (2).

y^{p}=softmax(wx+b) (2)

Here, in Expression (2), W corresponds to a matrix, and x, b, and y^{p} each correspond to a vector. Moreover, “softmax” represents the softmax function that outputs zᵢ=exp(aᵢ)/Σⱼexp(aⱼ) for each element aᵢ in the input vector.

In step S206, the second prediction unit 105 calculates a second feature from the entire image with the second network model and outputs a second prediction result. Similarly to the first network model, the second network model may be any model capable of extracting a feature from the entire image, such as CNN. Note that the second prediction result corresponds to a classification result to the entire image.

In step S207, the second confidence calculation unit 106 calculates a second confidence for the extracted second feature. Similarly to the first confidence, the second confidence is calculated for the position corresponding to each patch image in the entire image.

In step S208, the update unit 107 calculates a loss function. Herein, calculated is a loss function L for measuring the difference between the probability distribution of classification of the first prediction result and the probability distribution of classification of the second prediction result and the difference between the first confidence and the second confidence. For example, a loss function L1 indicating difference in probability distribution is given by Expression (3).

$$L 1 = ( 1 - α ) {L}^{f} ( {t}_{n} , {y}_{n}^{f} ( {θ}^{f} ) ) + \frac{α}{M} {\sum }_{m = 1}^{M} {L}^{p} ( {t}_{n} , {\hat{y}}_{n}^{f} , {y}_{n , m}^{p} ( {θ}^{p} ) , {\hat{y}}_{n , m}^{p} ( {θ}^{p} ) ) \qquad ( 3 )$$

Here, α∈[0, 1] represents a hyperparameter. M represents the number of types of resolution for patch images. In a case where the number of types of resolution for patch images is one, the following expression is satisfied: M=1. As described below, two or more types of resolution for patch images may be set.

tₙ represents a one-hot vector indicating an accuracy class and L^{f}( ) represents a loss function to the entire image, and thus a cross-entropy function C( ) is used. θ^{f} represents the parameter of the second network model (e.g., the weight factor and bias) and θ^{p} represents the parameter of the first network model (e.g., the weight factor and bias).

yₙ^{f}(θ^{p}) represents the second prediction result and y\hat{ }ₙ^{f} represents the second prediction result based on the softmax function with a temperature parameter. y_{n, m}^{p}(θ^{p}) represents the first prediction result to the m-th resolution in a case where the resolution for patch images varies to the n-th image. y\hat{ }_{n, m}^{p}(θ^{p}) represents the first prediction result to the m-th resolution in a case where the resolution for patch images varies to the n-th image, based on the softmax function with the temperature parameter.

yₙ^{f}(θ_{f}), y\hat{ }ₙ^{f}, y_{n, m}^{p}(θₚ), and y\hat{ }_{n, m}^{p}(θₚ) are calculated by Expression (4).

yₙ^{f}=softmax(lₙ^{f}),

ŷₙ^{f}=softmax(lₙ^{f}/T),

y_{n,m}^{p}=softmax(l_{n,m}^{p}),

ŷ_{n,m}^{p}=softmax(l_{n,m}^{p}/T) (4)

T represents the temperature parameter, lₙ^{f} represents the logit to the entire image, and l_{n, m}^{p} represents the logit to the m-th resolution in a case where the resolution for patch images varies to the n-th image.

Here, L^{p} in Expression (3) represents a loss function to a patch image and is defined by Expression (5).

L^{p}(tₙ,ŷₙ^{f},y_{n,m}^{p}(θ^{p}),ŷ_{n,m}^{p}(θ^{p}))=(1−β)C(tₙ,y_{n,m}^{p}(θ^{p}))+βT²KL(ŷₙ^{f}∥ŷ_{n,m}^{p}(θ^{p})) (5)

KL represents the Kullback-Leibler divergence. β satisfies the following expression: β∈[0, 1] and represents a hyperparameter for balancing between loss with accuracy (hard target) and loss due to knowledge distillation (soft target).

Meanwhile, a loss function L2 for measuring difference in confidence is given by Expression (6) with the sum of squared error (SSE) based on the first confidence cᵢ corresponding to each patch image and the second confidence dᵢ for the region corresponding to the patch image. Note that other techniques, such as the mean squared error (MSE) and the Kullback-Leibler divergence KL(d∥c), may be used.

L2=Σᵢ(dᵢ−cᵢ)² (6)

The final loss function L to be calculated in step S208 is given by the following expression: L=L1+γL2. Note that y represents a hyperparameter settable freely.

In step S209, the update unit 107 performs training such that the value of the loss function L is minimized, and determines whether or not the training of the first network model and the second network model has terminated. For determination of whether or not the training has terminated, for example, in a case where the loss value of the loss function L is less than a threshold, it may be determined that the training has terminated. Alternatively, in a case where the diminution of the loss value has converged, it may be determined that the training has terminated. Furthermore, in a case where a predetermined number of epochs of training have terminated, it may be determined that the training has terminated. In a case where the training has terminated, the processing terminates. In a case where the training has not terminated, the processing proceeds to step S210.

In step S210, the update unit 107 updates the parameter θ^{p} of the first network model and the parameter θ^{f} of the second network model. Specifically, for example, with gradient descent and/or backpropagation, the update unit 107 updates the respective weight factors and biases of the first network model and the second network model such that the loss value is minimized. After update of the parameters θ^{p} and θ^{f}, the processing goes back to step S203, leading to continuation of training of the first network model and the second network model.

Note that, in the example of FIG. 2, the second network model that outputs a prediction result of the entire image trains simultaneously with the first network model, but this is not limiting. As the second network model, a trained model having completed pre-training may be used. In this case, in step S210, the update unit 107 is required to update the parameter θ^{p} of the first network model while fixing the parameter θ^{f} of the second network model having already learned.

Exemplarily, the processing of calculating the first confidence in step S204 and the processing of calculating the second confidence in step S207 are performed, respectively, immediately after the processing of extracting the first feature in step S203 and the processing of extracting the second feature in step S206, but this is not limiting. For example, the first confidence calculation unit 104 may perform the processing of calculating the first confidence from each patch image in parallel to step S203. Similarly, the second confidence calculation unit 106 may perform the processing of calculating the second confidence from the entire image in parallel to step S206.

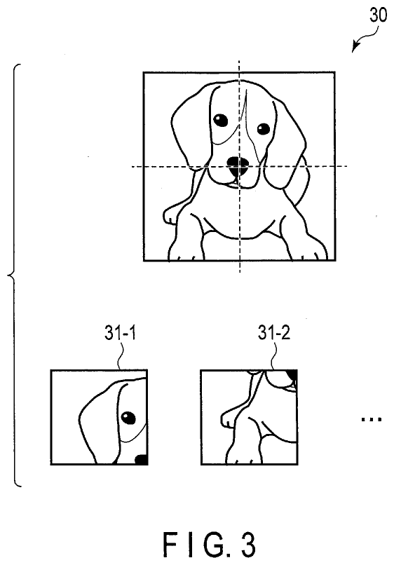

Next, exemplary division into patch images will be described with reference to FIG. 3.

In the example of FIG. 3, an entire image 30 is divided into quarters to generate four patch images. Division can be made such that an upper left patch image 31-1 and a lower left patch image 31-2 are acquired.

A method of dividing an entire image into patch images is not limited to, for example, division into patch images such that there is no overlap between divided regions based on a predetermined patch size, as in FIG. 3, and thus may be division into patch images such that the divided regions overlap partially. A region selected randomly from an entire image may be provided as a patch image. A region regarding a prediction target included in an entire image may be provided as a patch image. For a prediction target included in an entire image, for example, a rectangular region due to object detection may be provided as a patch image. If pixels are given the label of an object due to semantic segmentation processing, the region of an aggregate of the pixels given the label of the object may be provided as a patch image.

Furthermore, division may be made such that patch images are different in size. For example, made may be division into patch images different in size, such as a patch image one-fourth the size of the entire image and a patch image one-eighth the size of the entire image in combination. In a case where patch images are different in size, positional information to the entire image is required to be prescribed per corresponding size.

Generated may be patch images identical in size but different in image resolution. For example, due to selection of a patch image from an entire image and selection of a patch image from the entire image changed in resolution due to a reduction in the size of the entire image, the patch images different in resolution may be used in combination. In a case where there are variations in image resolution, with positional information corresponding to a patch image given to each entire image different in resolution, the plurality of entire images different in resolution is required to be input to the second network model for calculation of the corresponding second confidences. Alternatively, positional information on the regions corresponding to a plurality of patch images different in resolution in a single entire image may be prescribed to calculate the corresponding second confidences.

Note that information as to which position each divided patch image corresponds to in the entirety may be additionally used in identification. For example, the respective values resulting from min-max normalization of the ordinate and abscissa of the entire image (e.g., for 256 pixels, the values resulting from division of the coordinates, each ranging from 0 to 255, by 255) are added to each pixel value of the entire image. Alternatively, each normalized value may be used as input data to another channel. For example, in a case where the entire image corresponds to an RGB image, in addition to the three channels of R, G, and B images, the normalized values may be used as the fourth and fifth channels. Division of the entire image given such positional information as above causes each patch image to retain information on its position in the entirety, leading to an improvement in the performance of inference. Normalization processing is performed such that difference in resolution is absorbed by normalization.

In general, in a case where the size of a convolution kernel is two or more, padding processing is required, in which new pixels are added to the end portions of an image. Typically, regardless of position, a fixed value, such as zero, is substituted. However, changing such a value in accordance with patch position enables embedding of positional information.

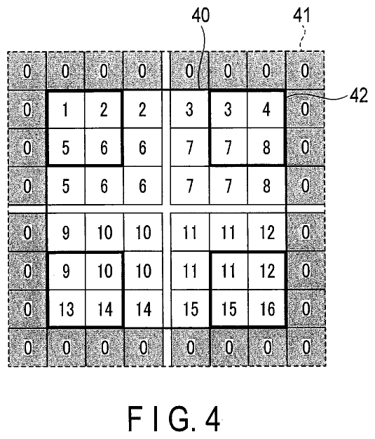

FIG. 4 illustrates exemplary embedding of positional information with a padding technique varying in accordance with the position of each patch image.

FIG. 4 illustrates the region of an entire image 40, an adjacent pixel region 41 outside by one pixel from the entire image, and the regions of patch images 42. For example, for quartering as illustrated in FIG. 4, zero padding may be used for the outside of the patch images and replicate (repetition of pixel values) padding may be used for the inside of the patch images. For example, the pixel values in the adjacent pixel region 41 adjacent to the upper right pixel value “4” of the upper right patch image 42 are set at “0” and the pixel value of the adjacent pixel just under the lower right pixel value “8” is set at “8”. Use of patch images given such positional information as above in inference causes each patch image to retain information on its position in the entirety, leading to an improvement in the performance of inference.

Note that pre-training of positional information corresponding to each patch image may be performed by self-supervised learning. For example, input of a patch image causes training of the first network model with, as a supervised label, the position of the patch image to the entire image based on the positional information acquired by the above method. Note that, in self-supervised learning, preferably, the first network model is trained with addition of a layer that outputs the position of a patch image from the first feature (e.g., ID of each divided region) as a class separation result.

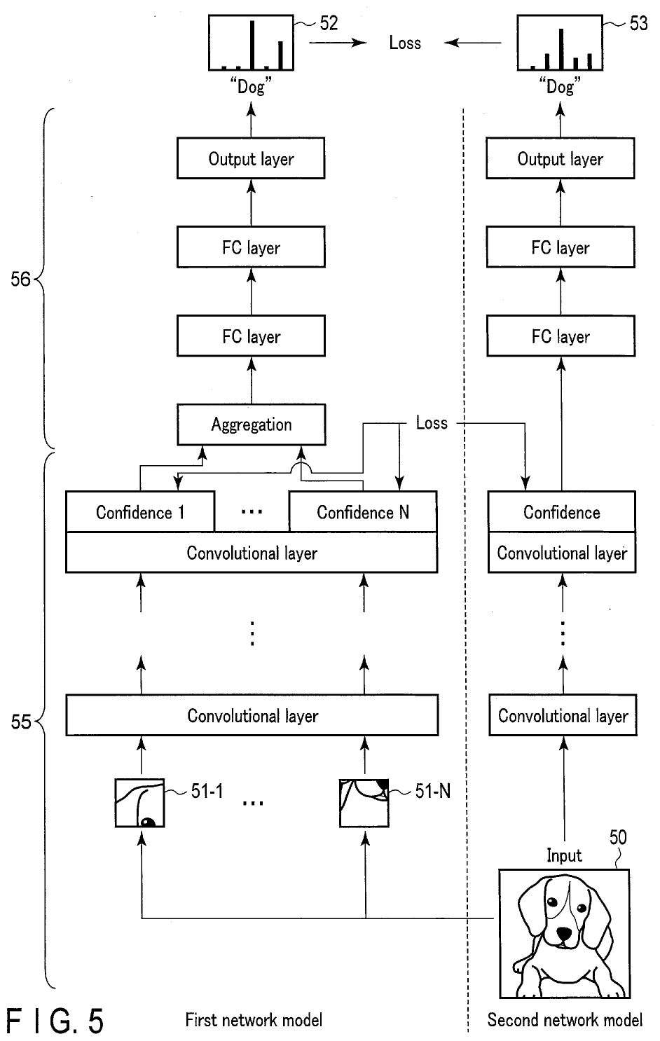

Next, a first exemplary structure of a first network model and a second network model will be described with reference to FIG. 5.

The first network model illustrated in FIG. 5 includes a plurality of convolutional layers, a two-stage fully connected layer (FC layer), and an output layer. Note that, herein, although the two-stage FC layer is provided, a single-stage FC layer or a three-or-more-stage FC layer may be provided or the output layer may be simply provided with no FC layer.

Each convolutional layer in FIG. 5 may be a single convolutional layer or may be a block unit including a plurality of convolutional layers, such as a residual block in ResNet.

The first convolutional layer in the first network model receives N number of patch images 51-1 to 51-N(N is a natural number of 2 or more) and extracts features from the patch images, so that the extracted features are input as intermediate data to the next convolutional layer.

Similarly to the first convolutional layer, the second and subsequent convolutional layers each extract features, so that the extracted features are input as intermediate data to the next convolutional layer. The convolutional layer just before the FC layer extracts a first feature and a first confidence corresponding thereto. In the example of FIG. 5, confidence 1 is calculated to the feature of the patch image 51-1, and confidence N is calculated to the feature of the patch image 51-N.

The features regarding the N number of patch images and the confidences corresponding thereto are aggregated, for example, by the processing in step S205 of FIG. 2 and then the aggregation is input to the two-stage FC layer for output of logit. The output layer applies, for example, the softmax function to the logit from the FC layer to output a probability distribution regarding a plurality of class separations as a first prediction result 52.

Meanwhile, the second network model includes a plurality of convolutional layers, a two-stage fully connected layer (FC layer), and an output layer, similarly to the first network model. The plurality of convolutional layers receives an entire image 50 and extracts a second feature for the entire image 50. The last convolutional layer calculates a second confidence corresponding to the second feature. At this time, based on positional information given to each patch image 51, the second confidence for the corresponding region is calculated from the entire image 50. Specifically, the patch image 51-1 corresponds to an upper left region of the entire image 50, and confidence for the upper left region corresponding to the patch image 51-1 in the entire image 50 is calculated as the second confidence.

The feature regarding the entire image is input to the two-stage FC layer for output of logit. The output layer applies, for example, the softmax function to the logit output from the FC layer to output a probability distribution regarding a plurality of class separations as a second prediction result 53.

Based on a loss function regarding the first prediction result 52 and the second prediction result 53 and a loss function regarding the first confidence and the second confidence, the parameters of the first network model and the second network model are updated repeatedly such that the loss value is minimized. Thus, due to training of the first network model and the second network model, the respective trained models of the first network model and the second network model are generated. Note that, in a case where the second network model has previously learned, only the first network model is trained.

Note that, exemplarily, the first confidence and the second confidence are each calculated based on the feature in the last convolutional layer, but may be each calculated based on the feature extracted from any of the convolutional layers.

In general, since a patch image is expressed as part of the entire image, the second prediction result is higher in the accuracy of classification than the first prediction result. Therefore, for a prediction for a probability distribution of classification due to patch images, knowledge is distilled from a prediction result for a probability distribution of classification due to the entire image, and furthermore the knowledge of the second confidence with the entire image is reflected to the first confidence with each patch image. Thus, for processing of an independent patch image, the knowledge of the entire image as to which divided region in the entire image contributes to a prediction result can be reflected to training of the first network model.

Note that, in distributed inference, for example, a partial network of the plurality of convolutional layers in the first network model is deployed as a feature extractor 55 for inference processing at a processing node as an edge device, and a predictor 56 is retained as a partial network including the FC layer and the output layer at a central node.

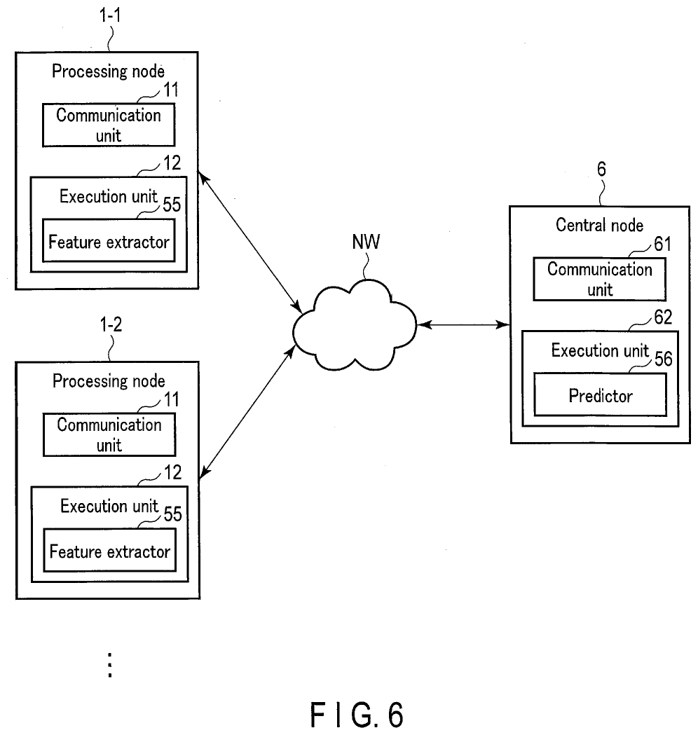

Here, a first exemplary inference system that performs distributed inference according to the present embodiment will be described with reference to FIGS. 5 and 6.

The inference system illustrated in FIG. 6 includes a plurality of processing nodes 1-1 and 1-2 and a single central node 6 connected through a network NW. Note that, in the example of FIG. 6, two processing nodes 1-1 and 1-2 are provided, but three or more processing nodes may be provided. In a case where no distinction is particularly required, each is simply referred to as a processing node 1.

Each processing node 1 includes a communication unit 11 and an execution unit 12. The execution unit 12 includes a feature extractor 55 as a network model regarding feature extraction included in such a first network model having already learned as illustrated in FIG. 5.

The communication unit 11 receives a patch image of an entire image to be subjected to inference processing from the central node 6.

The execution unit 12 inputs the patch image into the feature extractor 55 to extract a feature and

The communication unit 11 transmits the extracted feature and confidence to the central node 6.

Note that each processing node 1 may receive the entire image, divide a patch image from the entire image by itself, and perform processing to the divided patch image. In this case, each processing node 1 is required to grasp in advance the region of a patch image to be subjected to processing by itself, namely, positional information on a region to be divided from the entire image.

The central node 6 includes a communication unit 61 and an execution unit 62. The execution unit 62 includes such a predictor 56 as illustrated in FIG. 5.

The communication unit 61 receives the feature and confidence from each of the plurality of processing nodes 1.

The execution unit 62 performs ensemble processing for aggregation to the received features, based on the confidences. The communication unit 61 may receive only the feature from each of the plurality of processing nodes 1. In this case, the execution unit 62 is required to calculate confidence from each of the received features and perform ensemble processing. For confidence calculation, especially, a FC layer and a softmax layer may be used. The execution unit 62 inputs the aggregated feature into the predictor 56, to generate an inference result. As above, the features of the patch images subjected to processing by the processing nodes 1 are aggregated in the central node 6, enabling distribution of load in processing.

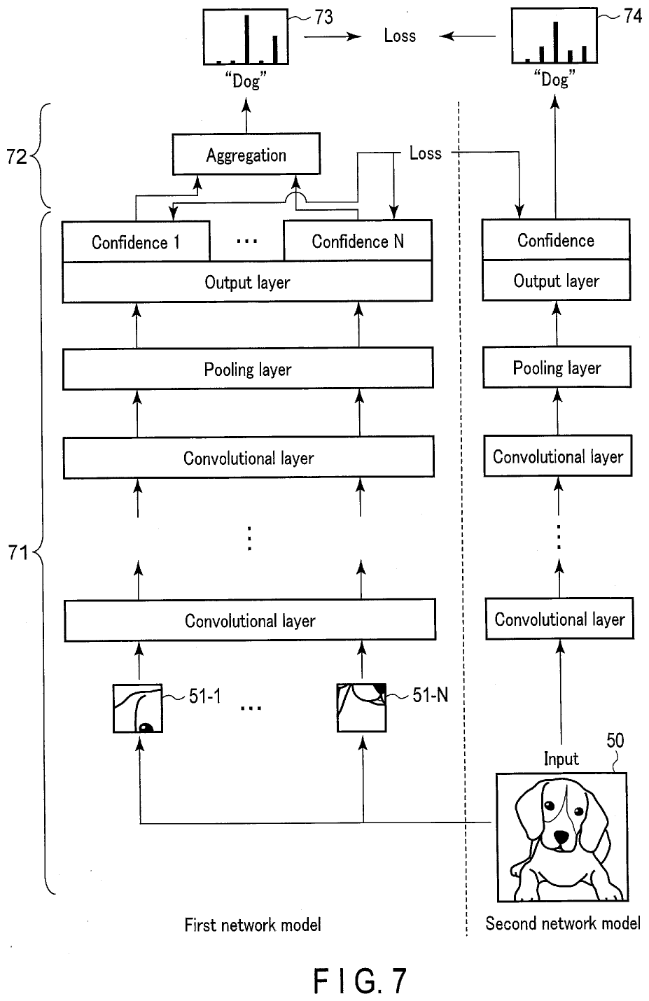

Note that any layers before aggregation in the network model are required to be arranged in each processing node, but a method for arrangement is not limited to the example of FIG. 5. A second exemplary structure of a first network model and a second network model will be described with reference to FIG. 7.

The second exemplary structure illustrated in FIG. 7 is different from the first exemplary structure in terms of aggregation processing after an output layer in each first network model 71. In each first network model 71, the feature extracted by the last convolutional layer is input to a pooling layer, and the output layer outputs a prediction result and confidence. The pooling layer performs processing such as global average pooling. An aggregation unit 72 aggregates the prediction results from the first network models 71, to generate an inference result 73. Meanwhile, similarly to the first network model, the second network model includes a plurality of convolutional layers, a pooling layer, and an output layer. Due to input of an entire image 50, a second prediction result 74 and confidence are output from the output layer. A method of calculating confidence and a method of training a network model are similar to those in the first exemplary structure.

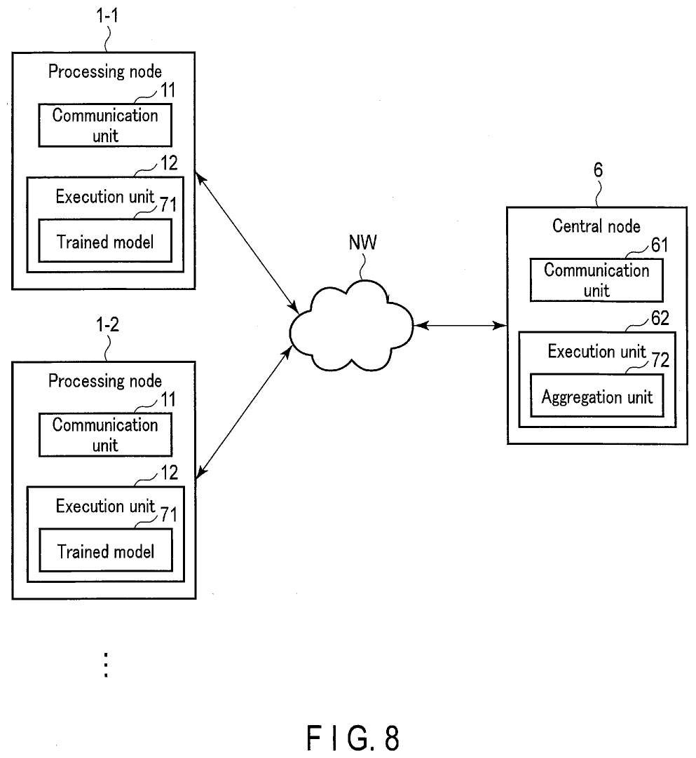

Next, a second exemplary inference system according to the second exemplary structure will be described with reference to FIG. 8.

Similarly to the inference system illustrated in FIG. 6, the inference system according to the second exemplary structure includes a plurality of processing nodes 1-1 and 1-2 and a single central node 6 connected through a network NW. The processing nodes 1 each have a first network model 71 having already trained, deployed therein, and the central node 6 includes an aggregation unit 72.

In each processing node 1, an execution unit 12 inputs a patch image into the first network model 71 having already learned, to generate a prediction result and confidence. After that, a communication unit 11 transmits the prediction result and confidence to the central node 6.

In the central node 6, a communication unit 61 receives the prediction result and confidence from each of the plurality of processing nodes 1. An execution unit 62 performs ensemble processing for aggregation to the received prediction results, based on the confidences, resulting in generation of an inference result.

Note that, in the present embodiment, the minimization with a loss function for measuring difference has been exemplarily given, but a problem of maximization of a function such as cosine similarity may be provided. That is, preferably, the parameters of the first network model and the second network model are updated such that the respective objective functions are optimized.

According to the first embodiment described above, in training of the first network model that processes partial data as part of target data, a first prediction result of the partial data and a first confidence indicating the degree of contribution to the inference of the first prediction result are calculated. Furthermore, calculated are a second prediction result regarding the entire target data and a second confidence indicating the degree of contribution to the inference of the second prediction result, acquirable from intermediate data of the second network model that processes the target data. With the difference between the first prediction result and the second prediction result and the difference between the first confidence and the second confidence as a loss function, training of the first network model enables knowledge distillation of the inference result of the target data to the inference of the partial data. Thus, distributed inference processing enables a reduction in communication cost and an improvement in the accuracy of inference of a trained model that processes partial data.

### Second Embodiment

In the first embodiment, the first network model and the second network model are different in parameter. However, in the second embodiment, a parameter is shared between network models.

The configuration of a learning apparatus 10 according to the second embodiment is similar to that according to the first embodiment, and thus the description thereof will be omitted.

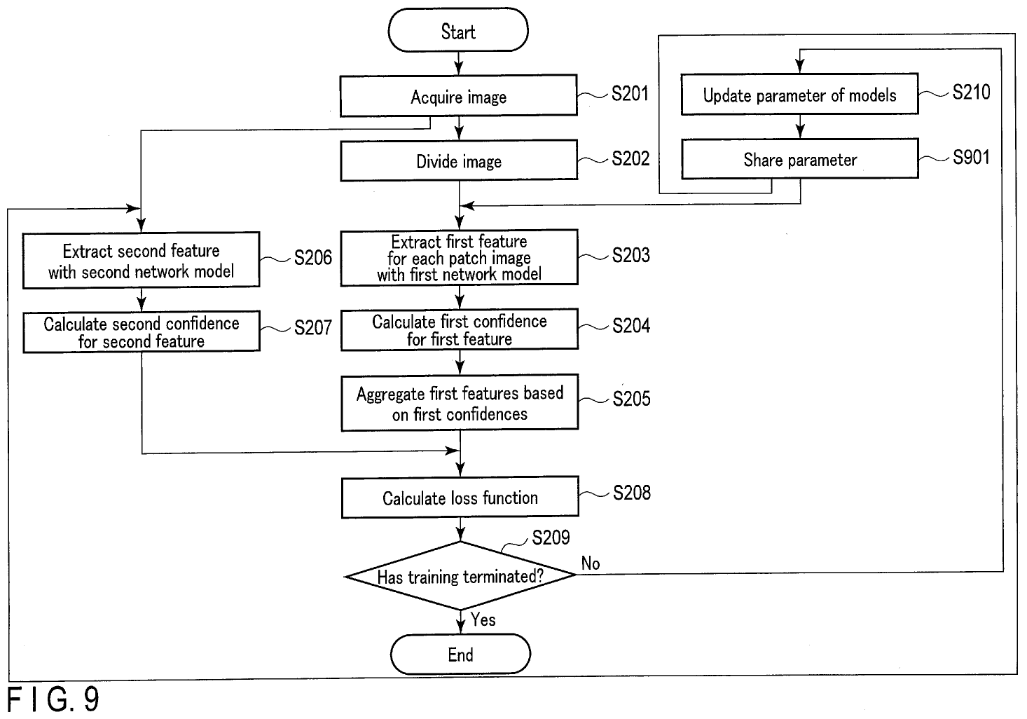

Exemplary training of the learning apparatus 10 according to the second embodiment will be described with reference to the flowchart of FIG. 9.

Note that, in the second embodiment, a first network model and a second network model are identical in network model structure and in parameter. Note that the example of FIG. 9 is not limiting and thus a parameter may be shared in part of each model structure and a different parameter and a different structure may be used for each remaining structure. In a case where a network model has a batch normalization layer, learnable weight and bias may be shared and the first network model and the second network model may each individually have mean and variance parameters.

Steps S201 to S210 are similar to those according to the first embodiment. Note that, in step S208 according to the second embodiment, a loss function L1 indicating difference in probability distribution is required to be calculated based on Expression (7) with the common parameter.

$$L 1 = ( 1 - α ) {L}^{f} ( {t}_{n} , {y}_{n}^{f} ( θ ) ) + \frac{α}{M} {\sum }_{m = 1}^{M} {L}^{p} ( {t}_{n} , {\hat{y}}_{n}^{f} , {y}_{n , m}^{p} ( {θ}^{p} ) , {\hat{y}}_{n , m}^{p} ( {θ}^{p} ) ) \qquad ( 7 )$$

In step S901, an update unit 107 causes the value of the parameter updated in step S210 to be shared between the first network model and the second network model. That is, the update unit 107 performs setting such that the first network model and the second network model have identical values in parameter.

According to the second embodiment described above, sharing of a parameter between the first network model and the second network model at the time of learning of a network model enables knowledge distillation. That is, learning of the entire image and a patch image with identical models leads to use of a parameter enabling inference with either the entire image or a patch image. Thus, information required for recognition of the entire image can be used to a patch image, so that an improvement can be made in the performance of a model. That is, similarly to the first embodiment, distributed inference processing enables a reduction in communication cost and an improvement in the accuracy of inference of a trained model that processes partial data.

### Third Embodiment

A third embodiment is different from the above embodiments in terms of sharing of a parameter with no calculation of confidence.

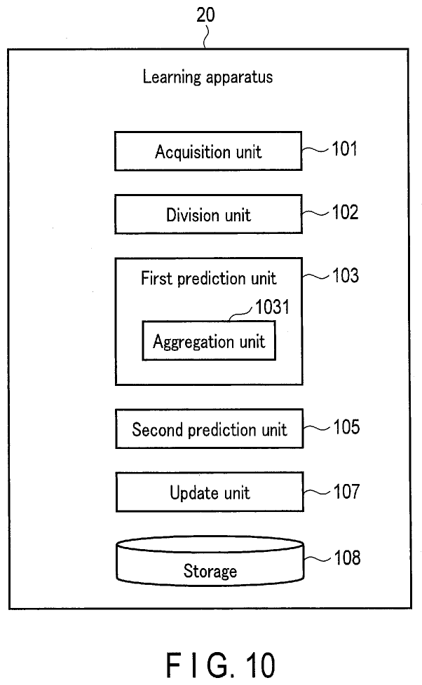

A learning apparatus according to the third embodiment will be described with reference to the block diagram of FIG. 10.

The learning apparatus 20 according to the third embodiment includes an acquisition unit 101, a division unit 102, a first prediction unit 103, a second prediction unit 105, an update unit 107, and a storage unit 108.

Similarly to the second embodiment, the update unit 107 causes a parameter to be shared between a first network model and a second network model.

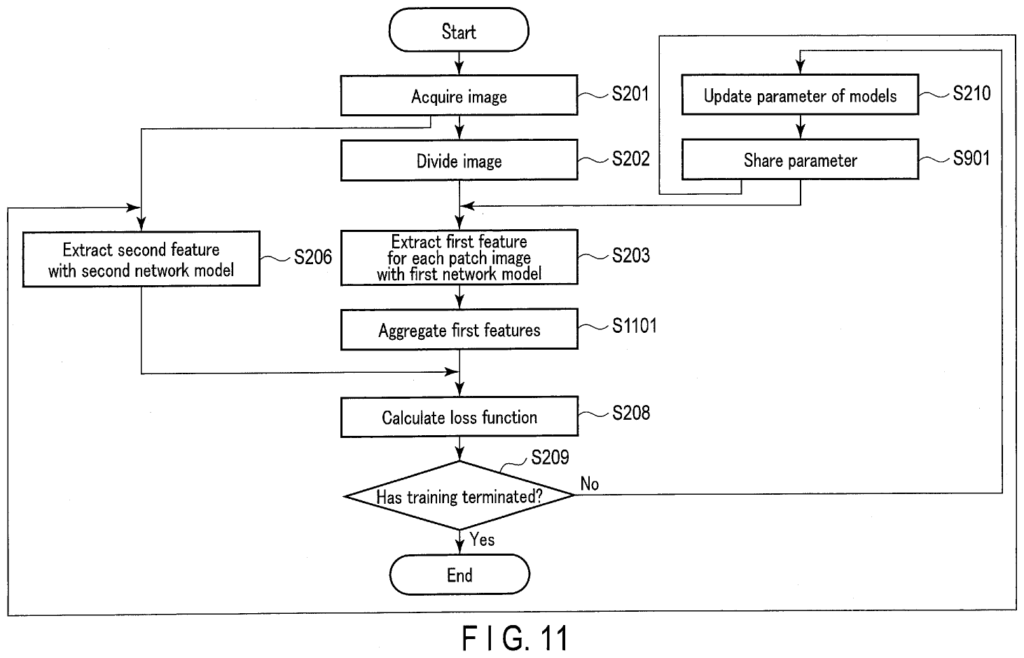

Next, exemplary training of the learning apparatus 20 according to the third embodiment will be described with reference to the flowchart of FIG. 11.

Steps S201 to S203, step S206, steps S208 to S210, and step S901 are similar to those according to the second embodiment.

In step S1101, an aggregation unit 1031 aggregates the respective features extracted to patch images. For example, preferably, an aggregated feature is calculated due to a simple mean with Expression (1), described above, in which the first confidence cᵢ is set as a uniform value.

For a loss function in step S208, preferably, used is a loss function L1 regarding only difference in probability distribution, such as Expression (3) described above.

According to the third embodiment described above, sharing of a parameter between the first network model and the second network model at the time of learning of a network model enables knowledge distillation, so that an improvement can be made in the performance of a model. As a result, similarly to the first embodiment, distributed inference processing enables a reduction in communication cost and an improvement in the accuracy of inference of a trained model that processes partial data.

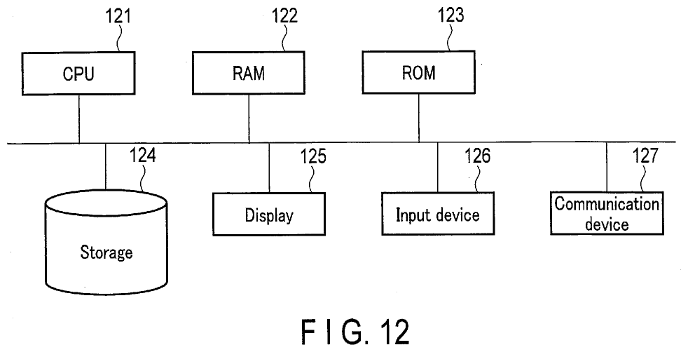

Next, an exemplary hardware configuration of each of the learning apparatus 10 and the learning apparatus 20 according to the above embodiments will be described with reference to the block diagram of FIG. 12.

The learning apparatus 10 and the learning apparatus 20 each include a central processing unit (CPU) 121, a random access memory (RAM) 122, a read only memory (ROM) 123, a storage 124, a display device 125, an input device 126, and a communication device 127 that are connected through a bus.

The CPU 121 serves as a processor that performs, for example, arithmetic processing and control processing in accordance with a program. In cooperation with the program stored in the ROM 123 or the storage 124, with a predetermined area in the RAM 122 as a work area, the CPU 121 performs processing of each unit in the learning apparatus 20 described above.

The RAM 122 is, for example, a synchronous dynamic random access memory (SDRAM). The RAM 122 functions as a work area for the CPU 121. The ROM 123 serves as a memory that stores a program and various types of information so as not to be rewritten.

The storage 124 serves as a magnetic recording medium, such as a hard disk drive (HDD), a semiconductor storage medium, such as a flash memory, or a device that writes data in or reads data from a magnetically recordable storage medium or an optically recordable storage medium. In accordance with control from the CPU 121, the storage 124 writes data in or reads data from a storage medium.

The display device 125 is, for example, a liquid crystal display (LCD). Based on a display signal from the CPU 121, the display device 125 displays various types of information.

The input device 126 includes, for example, a mouse and a keyboard. The input device 126 receives, as an instruction signal, information input due to an operation from a user and outputs the instruction signal to the CPU 121.

In accordance with control from the CPU 121, the communication device 127 communicates with an external device through a network.

The instructions in the processing procedure in each embodiment described above can be performed, based on a program as software. A general-purpose computer system stores such a program in advance and reads the program, enabling acquisition of an effect similar to the effect due to the control operation of the corresponding learning apparatus described above. The instructions in each embodiment described above are recorded as a computer-executable program on a magnetic disk (e.g., a flexible disk or a hard disk), an optical disc (e.g., a CD-ROM, a CD-R, a CD-RW, a DVD-ROM, a DVD±R, a DVD±RW, or a Blu-ray (registered trademark) disc), a semiconductor memory, or any recording medium similar thereto. In a case where a recording medium is computer-readable or embedded-system-readable, its storage format may be any form. A computer reads the program from such a recording medium and its CPU performs the instructions in the program, based on the program, resulting in achievement of operation similar to the control of the learning apparatus in the corresponding embodiment described above. In a case where a computer acquires or reads such a program, the computer may acquire or read the program through a network.

Based on the instructions in a program installed from a recording medium into a computer or embedded system, for example, an operating system (OS) operating on the computer, database management software, or middleware (MW), such a network, may perform part of each piece of processing for achievement of the present embodiment.

Furthermore, a recording medium in the present embodiment is not limited to a medium independent of a computer or embedded system. Provided may be a recording medium that stores or temporarily stores, due to download, a program transmitted through a LAN or the Internet.

The number of recording media is not limited to one. Even in a case where the processing in the present embodiment is performed from a plurality of media, the plurality of media is not limited in configuration.

Note that a computer or embedded system in the present embodiment performs each piece of processing in the present embodiment, based on a program stored in a recording medium. Provided may be a personal computer, a single apparatus including a microcomputer, or a system including a plurality of apparatuses connected through a network.

The “computer” in the present embodiment is a generic term for devices and apparatuses capable of achieving the function in the present embodiment, based on a program, inclusive of an arithmetic processing device or a microcomputer included in an information processing device, in addition to personal computers.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning apparatus comprising a processor configured to:
divide target data into pieces of partial data;
input the pieces of partial data into a first network model to output a first prediction result;
calculate a first confidence indicating a degree of contribution to the first prediction result, for each of the pieces of partial data;
input the target data into a second network model to output a second prediction result;
calculate a second confidence indicating a degree of contribution to the second prediction result, for a region corresponding to each of the pieces of partial data in the target data; and
update a parameter of the first network model, based on the first prediction result, the second prediction result, the first confidence and the second confidence.

2. The apparatus according to claim 1, wherein the first network model and the second network model are partially or entirely identical in model structure and share part or an entirety of the parameter.

3. The apparatus according to claim 1, wherein the processor calculates an objective function based on the first prediction result, the second prediction result, the first confidence, and the second confidence, and updates the parameter such that a value of the objective function is optimized.

4. The apparatus according to claim 1, wherein the processor is further configured to:
generate intermediate data regarding feature extraction of the pieces of partial data from the first network model;
weight the intermediate data, based on the first confidence;
perform ensemble processing to the weighted intermediate data; and
output the first prediction result, based on the intermediate data after the ensemble processing.

5. The apparatus according to claim 1, wherein the first confidence is calculated based on saliency or attention of intermediate data of the first network model, and the second confidence is calculated based on saliency or attention of intermediate data of the second network model.

6. A learning apparatus comprising a processor configured to:
divide target data into pieces of partial data;
input the pieces of partial data into a first network model, to output a first prediction result;
input the target data into a second network model that is partially or entirely identical in model structure to the first network model and shares part or an entirety of a parameter with the first network model, to output a second prediction result; and
update the parameter, based on the first prediction result and the second prediction result.

7. The apparatus according to claim 1, wherein each of the pieces of partial data corresponds to at least one of a region partially overlapping in the target data, a region not overlapping in the target data, a region randomly selected from the target data, and a region regarding a prediction target included in the target data.

8. A learning method comprising:
dividing target data into pieces of partial data;
inputting the pieces of partial data into a first network model to output a first prediction result;
calculating a first confidence indicating a degree of contribution to the first prediction result, for each of the pieces of partial data;
inputting the target data into a second network model to output a second prediction result;
calculating a second confidence indicating a degree of contribution to the second prediction result, for a region corresponding to each of the pieces of partial data in the target data; and
updating a parameter of the first network model, based on the first prediction result, the second prediction result, the first confidence and the second confidence.

9. The method according to claim 8, wherein the first network model and the second network model are partially or entirely identical in model structure and share part or an entirety of the parameter.

10. The method according to claim 8, wherein the calculating the first confidence and the second confidence calculates an objective function based on the first prediction result, the second prediction result, the first confidence, and the second confidence, and updating the parameter such that a value of the objective function is optimized.

11. The method according to claim 8, further comprising
generating intermediate data regarding feature extraction of the pieces of partial data from the first network model;
weighting the intermediate data, based on the first confidence;
performing ensemble processing to the weighted intermediate data; and
outputting the first prediction result, based on the intermediate data after the ensemble processing.

12. The apparatus according to claim 8, wherein the first confidence is calculated based on saliency or attention of intermediate data of the first network model, and the second confidence is calculated based on saliency or attention of intermediate data of the second network model.

13. An inference system comprising a plurality of processing nodes and a central node,
the processing nodes each comprising:
a feature extractor as a network model regarding feature extraction included in a first network model having already trained due to the learning apparatus according to claim 1; and
a first processor configured to:
input partial data of target data into the feature extractor to extract a feature; and
transmit the feature to the central node,
the central node comprising a second processor configured to receive the feature from each of the processing nodes; and
a predictor as a network model included in the first network model having already trained, the predictor being configured to perform processing corresponding to a task to the feature,
wherein the second processor performs ensemble processing to the plurality of features transmitted from the plurality of processing nodes and inputs the features subjected to the ensemble processing into the predictor, to generate an inference result.
